(19) United States
(12) Patent Application Publication
(10) Pub. No.: US 2021/0387088 A1
(43) Pub. Date: Dec. 16, 2021

(54) CONTROL PROGRAM, CONTROL METHOD, GAME DEVICE, AND TERMINAL DEVICE

(71) Applicant: GREE, INC., Tokyo (JP)

(72) Inventor: Yusuke OZAWA, Tokyo (JP)

(73) Assignee: GREE, INC., Tokyo (JP)

(21) Appl. No.: 17/412,907

(22) Filed: Aug. 26, 2021

Related U.S. Application Data
(63) Continuation of application No. 15/937,900, filed on Mar. 28, 2018.

(30) Foreign Application Priority Data
Mar. 31, 2017 (JP) 2017-073025

(51) Int. Cl. A63F 13/46; A63F 13/44; A63F 13/48; A63F 13/352; A63F 13/332

(52) U.S. Cl. CPC A63F 13/46; A63F 13/44; A63F 13/48; A63F 13/52; A63F 13/332; A63F 2300/61; A63F 13/352

(57) ABSTRACT

An electronic device stores information relating to an attribute associated with each of a plurality of sites of a game field in memory. The device further stores a group including at least one player, a game content associated with the player, and an attribute associated with the game content in the storage unit. The device associates the game content as a site content with a site designated by the player among the plurality of sites in response to a request from the player and determines points corresponding to the site content on the basis of a relation between an attribute of the site content and an attribute of the designated site.

### CROSS REFERENCE TO RELATED APPLICATIONS

This is a Continuation of application Ser. No. 15/937,900 filed Mar. 28, 2018, which claims priority from Japanese patent application JP 2017-073025 filed on Mar. 31, 2017. The entire disclosure of each of the above-identified applications is hereby incorporated by reference into this application.

### BACKGROUND

### 1. Technical Field

The present disclosure relates to a control program, a control method, a game device, and a terminal device.

### 2. Related Art

Conventionally, encampment games are known in which each player associates a point such as virtual currency with a territory set in a game field, and a player associating the most points with a territory can own the territory.

For example, in JP 2014-46033 A, a game system including a terminal device and a server apparatus providing an area competition game for the terminal device has been disclosed. In this game system, when a first player executes a direction for setting a player point to an area, only in a case where the player point of the first player is larger than the player point of any other player that has already been set to the area, the player point of the first player is set to the area. Then, the area to which the player point is set is set as a territory of the first player corresponding to the player point. In this way, the game system disclosed in JP 2014-46033 A can provide an encampment game including an element of a battle game for players.

### SUMMARY

However, in a conventional game, the owning of a territory of each player is determined in accordance with only a total quantity of point associated with the area by the player, and accordingly, there is low necessity for the player to elaborate a strategy for winning the game. In addition, in the conventional game, in a final state of a game, players can predict a victory/defeat of the game, and there are cases where motivation for continuing the game decreases.

An object of the present disclosure is to provide a control program, a control method, a game device, and a terminal device capable of advancing a game requiring a strategy of a high level according to an attribute associated with a game content that is a player's operation target for achieving an object using a user interface that can be easily operated even by a novice player.

In order to achieve the above-mentioned object, according to an aspect of the present disclosure, there is provided a non-transitory computer-readable recording storage medium containing a program, the program, at the time of execution using a processor of a server, causing the processor to execute: storing information relating to an attribute associated with each of a plurality of sites of a game field, a group including at least one player, a game content associated with the player, and an attribute associated with the game content in a storage unit; associating the game content as a site content with a site designated by the player among the plurality of sites in response to a request from the player; determining points corresponding to the site content on the basis of a relation between an attribute of the site content and an attribute of the designated site; storing a sum of points corresponding to the site content associated with each of the plurality of sites by players included in the group in the storage unit as site points of the group for the site; and progressing the game on the basis of the site points of the group for each of the sites.

According to another aspect, there is provided a non-transitory computer-readable recording storage medium containing a program, the program, at the time of execution using a processor of a server, causing the processor to execute: storing information relating to an attribute associated with each of a plurality of sites of a game field, a group associated with a player, a game content associated with the player, and an attribute associated with the game content in a storage unit; associating the game content with a site designated by the player among the plurality of sites as a site content; determining points corresponding to the site content on the basis of a relation between an attribute of the site content and an attribute of the designated site; presenting a sum of points corresponding to the site content associated by the player with each of the plurality of sites and points corresponding to the site content associated by another player associated with the group to the player as site points of the group for the site; and progressing the game on the basis of the site points of the group for each of the sites.

According to another aspect, there is provided a method of controlling a game device, the method comprising: storing information relating to an attribute associated with each of a plurality of sites of a game field, a group including at least one player, a game content associated with the player, and an attribute associated with the game content in a storage unit; associating the game content as a site content with a site designated by the player among the plurality of sites in response to a request from the player; determining points corresponding to the site content on the basis of a relation between an attribute of the site content and an attribute of the designated site; storing a sum of points corresponding to the site content associated with each of the plurality of sites by players included in the group in the storage unit as site points of the group for the site; and progressing the game on the basis of the site points of the group for each of the sites.

According to another aspect, there is provided a method of controlling a terminal device, the method comprising: storing information relating to an attribute associated with each of a plurality of sites of a game field, a group associated with a player, a game content associated with the player, and an attribute associated with the game content in a storage unit; associating the game content with a site designated by the player among the plurality of sites as a site content; determining points corresponding to the site content on the basis of a relation between an attribute of the site content and an attribute of the designated site; presenting a sum of points corresponding to the site content associated by the player with each of the plurality of sites and points corresponding to the site content associated by another player associated with the group to the player as site points of the group for the site; and progressing the game on the basis of the site points of the group for each of the sites.

According to another aspect, there is provided a game device comprising a circuit, the circuit configured to execute: storing information relating to an attribute associated with each of a plurality of sites of a game field, a group including at least one player, a game content associated with the player, and an attribute associated with the game content in a storage unit; associating the game content as a site content with a site designated by the player among the plurality of sites in response to a request from the player; determining points corresponding to the site content on the basis of a relation between an attribute of the site content and an attribute of the designated site; storing a sum of points corresponding to the site content associated with each of the plurality of sites by players included in the group in the storage unit as site points of the group for the site; and progressing the game on the basis of the site points of the group for each of the sites.

According to another aspect, there is provided a terminal device comprising a circuit, the circuit configured to execute: storing information relating to an attribute associated with each of a plurality of sites of a game field, a group associated with a player, a game content associated with the player, and an attribute associated with the game content in a storage unit; associating the game content with a site designated by the player among the plurality of sites as a site content; determining points corresponding to the site content on the basis of a relation between an attribute of the site content and an attribute of the designated site; presenting a sum of points corresponding to the site content associated by the player with each of the plurality of sites and points corresponding to the site content associated by another player associated with the group to the player as site points of the group for the site; and progressing the game on the basis of the site points of the group for each of the sites.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the presently preferred embodiments together with the accompanying drawings in which:

FIGS. 1A and 1B are schematic diagrams illustrating an example of a game provided by a game device;

FIGS. 2A and 2B are schematic diagrams for illustrating examples of games provided by a game device;

FIG. 3 is a diagram illustrating an example of the schematic configuration of a game system 1;

FIG. 4 is a diagram illustrating an example of the schematic configuration of a mobile terminal 2;

FIGS. 5A to 6B are diagrams illustrating examples of views displayed on a display 24 of the mobile terminal 2;

FIG. 7 is a diagram illustrating an example of the schematic configuration of a server 3;

FIGS. 8A to 11B are diagrams illustrating examples of the data structures of various tables;

FIG. 12 is a diagram illustrating one example of the operation sequence of the game system 1; and

FIG. 13 is a diagram illustrating one example of the operation flow of a progressing process.

### DETAILED DESCRIPTION OF THE PREFERRED EMBODIMENTS

Hereinafter, various embodiments of the present disclosure will be described with reference to the drawings. However, it should be noted that the technical scope of the present disclosure is not limited to such embodiments and extends to inventions described in the claims and equivalents thereof.

### Overview of This Embodiment

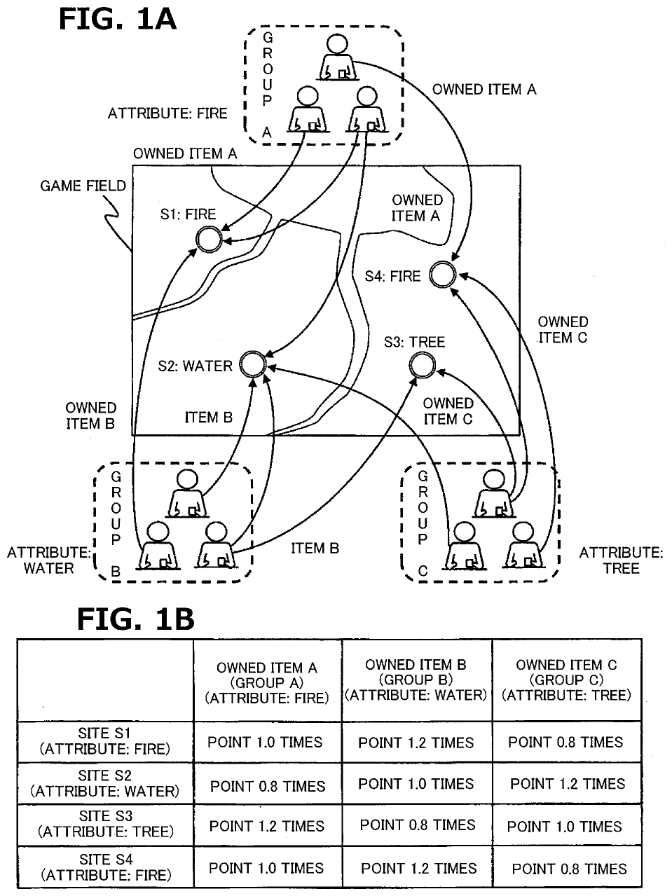

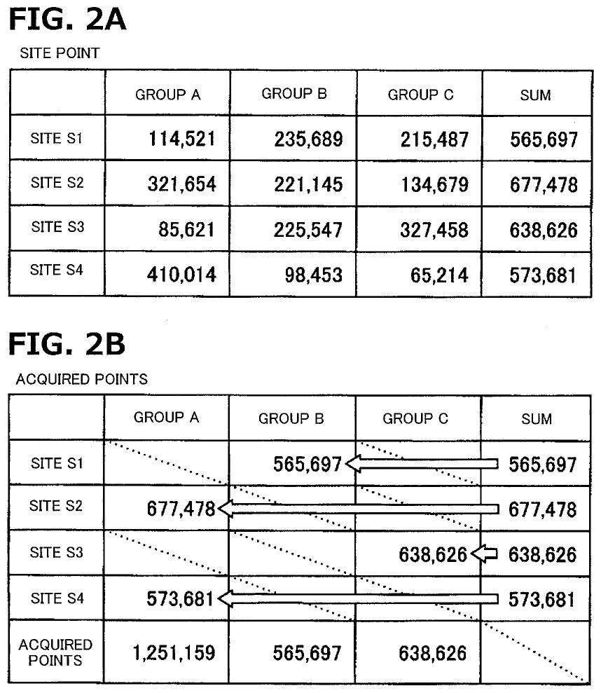

Hereinafter, an example of a game provided by a game device according to this embodiment will be described with reference to FIGS. 1A to 2B. A game device is a mobile terminal held by each player participating in a game, a server communicating with the mobile terminal, or the like.

In this embodiment, the game device has a game execution function executing a battle between a plurality of groups each associated with at least one player. A battle game between groups is a so-called guild versus guild (GvG) game in which a battle is executed using a game content associated with each player belonging to each of the plurality of groups. In the game device according to this embodiment, by associating players with each group, the players belong to the group. Hereinafter, a player associated with a group may be referred to as a belonging player of the group. A belonging player of a group is not limited to a player belonging to the group in a game but may be a player having a predetermined relation with the group in the game or the like.

A group is a player group configured by at least one belonging player for participating in all or some games provided by a game device and is a so-called guild, a clan, a party, or the like. A game content is electronic data corresponding to an arbitrary object used in a game such as an item or the like. The game content is not limited to an item but, for example, may correspond to a character, an avatar, a card, or the like or may correspond to a point, a parameter, or the like. The game content may be any data as long as it is electronic data that can be obtained, owned, used, managed, exchanged, composed, reinforced, sold, disposed, donated, and/or the like inside a game by a belonging player in accordance with the progress of the game, and the use form of the game content is not limited to that explicitly illustrated in this specification.

In the game device according to this embodiment, by associating one or a plurality of items with a player, the player owns the items. Hereinafter, an item associated with a player may be referred to as an owned item. An owned item is not limited to an item that is owned or occupied by a player in a game but may be any item, as long as it is an item that can be used by the player in a game.

Hereinafter, as a game progressed by the game device, a game in which a plurality of groups (group A, group B, and group C) participate will be described as an example. A belonging player of each group, by operating the game device displaying a game field including a plurality of sites on a display screen, designates an arbitrary site among the plurality of sites and executes the game for associating an owned item of the belonging player with the designated site.

As illustrated in FIG. 1A, the game field is a two-dimensional or three-dimensional virtual game space displayed on the display screen of the game device. A site S1 to a site S4 are predetermined points or closed areas that are arranged inside the game field and designated by belonging players. In addition, a site mark representing each site is displayed at each of the site S1 to the site S4.

The game device, in the middle of the progress of a game, in accordance with a direction of each belonging player of each of a plurality of groups, associates owned items of each belonging player with each site designated by each belonging player. For example, in a case where the site S1 is designated by a belonging player of the group A, an owned item A of the belonging player is associated with the site S1. In addition, in a case where the site S2 is designated by a belonging player of the group B, an owned item B of the belonging player is associated with the site S2. Furthermore, in a case where the site S3 is designated by a belonging player of the group C, an owned item C of the belonging player is associated with the site S3.

Unique item points are associated with an owned item, and, in a case where an owned item of a belonging player is associated with each site, the item points of the owned item are associated with each site. For example, in a case where the owned item A is associated with the site S1 by a belonging player of the group A, the item points (for example, 1000 points) of the owned item A are associated with the site S1. In addition, in a case where the owned item B is associated with the site S2 by a belonging player of the group B, the item points (for example, 800 points) of the owned item B are associated with the site S2. Furthermore, in a case where the owned item C is associated with the site S3 by a belonging player of the group C, the item points (for example, 1,200 points) of the owned item C are associated with the site S3.

In the game device according to this embodiment, at a time point at which a game starts, attributes are associated with each group and each site. For example, as illustrated in FIGS. 1A and 1B, an attribute “Fire” is associated with the site S1, an attribute “Water” is associated with the site S2, an attribute “Tree” is associated with the site S3, and an attribute “Fire” is associated with the site S4. In addition, as an attribute of an owned item, an attribute associated with a group to which a belonging player owning the owned item belongs may be associated. For example, an attribute “Fire” is associated with the owned item A of each belonging player of the group A, an attribute “Water” is associated with the owned item B of each belonging player of the group B, and an attribute “Tree” is associated with the owned item C of each belonging player of the group C. In addition, an attribute that is the same or different from that of a belonging player owning an item may be associated with the owned item in advance.

Among such attributes “Fire”, “Water”, and “Tree”, superiority/inferiority relations are set. Thus, for example, superiority/inferiority relations among the attributes are set such that the attribute “Water” is superior to the attribute “Fire”, the attribute “Tree” is superior to the attribute “Water”, and the attribute “Fire” is superior to the attribute “Tree”.

In the process of associating item points described above with a site, on the basis of the superiority/inferiority relation between the attribute of an owned item associated with each site and the attribute of each site, the item points of the owned item associated with each site are changed. For example, in a case where the attribute of the owned item associated with each site is superior to the attribute of each site, points that are 1.2 times the item points of the owned item are associated with each site. On the other hand, in a case where the attribute of the owned item associated with each site and the attribute of each site are the same, points that are 1.0 times the item points of the owned item are associated with each site. In addition, in a case where the attribute of the owned item associated with each site is inferior to the attribute of each site, points that are 0.8 times the item points of the owned item are associated with each site. Hereinafter, item points after change associated with each site by a belonging player may be referred to as associated points.

In the example illustrated in FIG. 1B, since the attribute of the owned item A of a belonging player of the group A is “Fire”, in a case where the owned item A is associated with the site S1 having the same attribute, associated points that are 1.0 times the item points of the owned item A are associated with the site S1. In addition, in a case where the owned item A of a belonging player of the group A is associated with the site S2 having the attribute “Water”, associated points that are 0.8 times the item points of the owned item A are associated with the site S2. Furthermore, in a case where the owned item A of a belonging player of the group A is associated with the site S3 having the attribute “Tree”, associated points that are 1.2 times the item points of the owned item A are associated with the site S3. In this way, on the basis of a relation between the owned item associated with the site and the site, associated points corresponding to the owned item are determined. Here, an owned item associated with a site is an example of the site content.

Next, for each of the site S1 to the site S4, a sum of associated points associated by belonging players of each group is stored as site points of each group of each of the site S1 to the site S4. The process of storing the site points is executed at a predetermined timing. Here, the predetermined timing, for example, is each time when a predetermined period (one second or the like), when an owned item is selected or associated points are associated by a player, when the progress of a game ends, or the like.

FIG. 2A illustrates an example of site points of each of the site S1 to the site S4 when the progress of a game ends. For example, from the start of a game to the end of the game, the site points of the group A at the site S1 are a sum (114,521 points) of associated points corresponding to the owned item A associated with the site S1 by the belonging players of the group A.

Next, each of the site S1 to the site S4 is set as an occupied site of a group corresponding to the most site points among site points for the site among the groups A to C. For example, a group corresponding to the most site points for the site S1 is the group B, and the site S1 is set as an occupied site of the group B. In addition, a group corresponding to the most site points for the site S2 is the group A, and the site S2 is set as an occupied site of the group A. Furthermore, a group corresponding to the most site points for the site S3 is the group C, and the site S3 is set as an occupied site of the group C. In addition, a group corresponding to the most site points for the site S4 is the group A, and the site S4 is set as an occupied site of the group A. A group having each site as its occupied site may be referred to as a site occupying group of each site.

A sum of site points of each of the group A, the group B, and the group C for each site is tabulated as acquired points of the site occupying group of each site. An example illustrated in FIG. 2B, as acquired points of the group B that is the site occupying group of the site S1, 565,697 points that are a sum of the site points of the group A, the group B, and the group C for the site S1 are tabulated. Similarly, the acquired points of the group A that is the site occupying group of the site S2 are 677,478 points, the acquired points of the group C that is the site occupying group of the site S3 are 638,626 points, and the acquired points of the group A that is the site occupying group of the site S4 are 573,681 points. Accordingly, in a case where the progress of the game ends, total acquired points of the group A are 1,251,159 points, total acquired points of the group B are 565,697 points, and total acquired points of the group C are 638,626 points.

As above, as described with reference to FIGS. 1A to 2B, in the game device according to this embodiment, for each of the site S1 to the site S4, a sum of associated points corresponding to owned items associated with the belonging players of each group is site points of each group for each of the site S1 to the site S4, and the game progresses on the basis of the site points of each group for each of the site S1 to the site S4. Accordingly, in a game realized by this game device, for example, a belonging player of a group is requested to have strategy planning of not associating his owned items with a site that is unlikely to be an occupied site of his group or the like. In this way, the game device can improve the amusement of the game.

The description presented with reference to FIGS. 1A and 1B described above is merely description for deep understanding of the content of the present disclosure. The present disclosure, more specifically, is performed by each embodiment to be described next and may be performed by various modified examples not substantially exceeding the principle of the present disclosure. All such modified examples belong to the present disclosure and the disclosed range of this specification.

(Configuration of Game System 1)

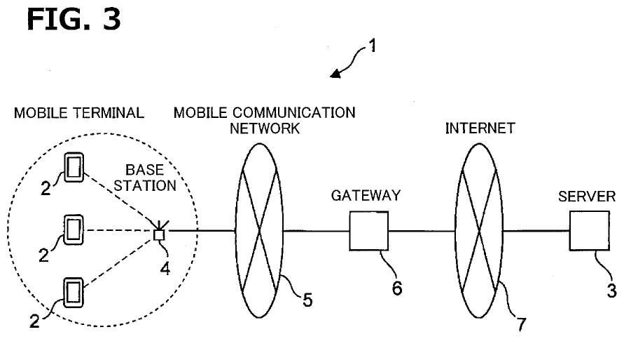

FIG. 3 illustrates an example of the schematic configuration of a game system 1.

The game system 1 includes a plurality of mobile terminals 2 operated by a plurality of players and a server 3. The mobile terminals 2 and the server 3, for example, are interconnected through a communication network such as a base station 4, a mobile communication network 5, a gateway 6, the Internet 7, and the like. A program (for example, a display processing program) executed by the mobile terminal 2 and a program (for example, a game program) executed by the server 3 communicate with each other by using a communication protocol such as a hypertext transfer protocol (HTTP). Here, while the mobile terminal 2 is an example of a game device providing a game, the game device is not limited to the mobile terminal 2. For example, the server 3 may be used as a game device. In addition, the game system 1 including the mobile terminals 2 and the server 3 may be used as a game device. Here, the mobile terminal 2 is an example of a terminal device.

As the mobile terminal 2, while a multi-function mobile phone (a so-called smartphone) is assumed, the present disclosure is not limited thereto. The mobile terminal 2 may be any device to which the present disclosure can be applied and, for example, may be a mobile phone (a so-called feature phone), a personal digital assistant (PDA), a mobile gaming device, a mobile music player, or an information processing apparatus such as a tablet terminal, a terminal personal computer (PC), or a notebook PC.

(Configuration of Mobile Terminal 2)

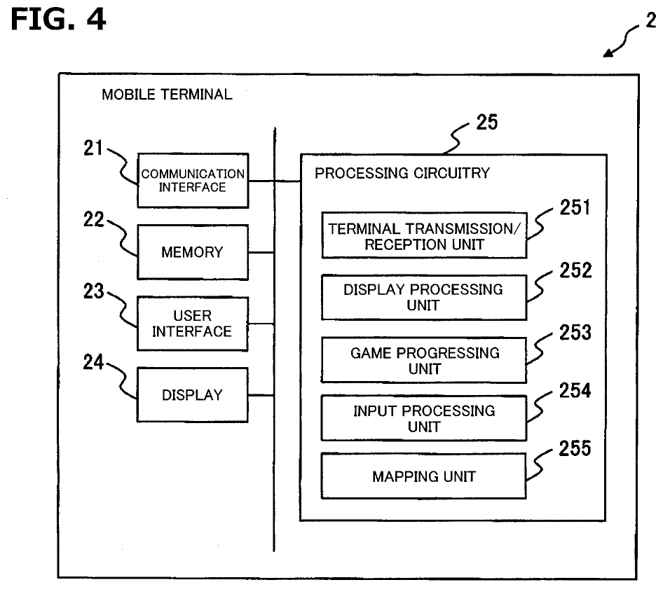

FIG. 4 illustrates an example of the schematic configuration of the mobile terminal 2.

The mobile terminal 2 is connected to the server 3 through the base station 4, the mobile communication network 5, the gateway 6, and the Internet 7 and communicates with the server 3. The mobile terminal 2 controls the progress of a game in accordance with an operation of a user interface 23 (a touch panel or the like) performed by a player. In addition, the mobile terminal 2 receives display data from the server 3 and displays various views relating to the progress of a game. For this reason, the mobile terminal 2 includes a communication interface 21, a memory 22, the user interface 23, a display 24, and a processing circuitry 25.

The communication interface 21 includes an antenna having a predetermined frequency band as its reception band, includes a communication interface circuit, and connects the mobile terminal 2 to a radio communication network. The communication interface 21 establishes a radio signal line using a code division multiple access system (CDMA) or the like with the base station 4 through a channel assigned by the base station 4 and communicates with the base station 4. Then, the communication interface 21 transmits data supplied from the processing circuitry 25 to the server 3 and the like. In addition, the communication interface 21 supplies data received from the server 3 or the like to the processing circuitry 25.

The memory 22, for example, includes a semiconductor memory device. The memory 22 stores an operating system program used for the process of the processing circuitry 25, driver programs, application programs including a game control program, data, and the like. For example, the memory 22, as the driver programs, stores an input device driver program controlling the user interface 23, an output device driver program controlling the display 24, and the like. In addition, the memory 22, as the application programs, stores a display processing program that progresses a game on the basis of direction data input in accordance with an operation of the user interface 23 that is performed by a player, data retrieved from the server 3, and the like and displays display data relating to the progress of the game, and the like. The memory 22, as data, stores data (various tables and the like to be described later) retrieved from the server 3, data representing a superiority/inferiority relation between attributes, game data such as associated points associated with each site ID and the like, display data, video data, image data, and the like relating to the progress of a game. In addition, the memory 22 may temporarily store temporary data relating to a predetermined process.

The user interface 23 may be any device that can operate the mobile terminal 2 and, for example, is a pointing device such as a touch panel. A player can input a character, a number, a symbol, a position on a display screen of the display 24, and the like by using the user interface 23. When operated by a player, the user interface 23 generates a signal corresponding to the operation. Then, the generated signal is supplied to the processing circuitry 25 as a player's direction.

The display 24 may be any device that can display a video, an image, and the like and, for example, is a liquid crystal display, an organic electroluminescence (EL) display, or the like. The display 24 displays a video corresponding to video data supplied from the processing circuitry 25, an image corresponding to image data, and the like.

The processing circuitry 25 includes one or a plurality of processors and peripheral circuits thereof. The processing circuitry 25 integrally controls the overall operation of the mobile terminal 2 and, for example, is a central processing unit (CPU). The processing circuitry 25 controls the operations of the communication interface 21, the display 24, and the like such that various processes of the mobile terminal 2 are executed in an appropriate sequence on the basis of a program stored in the memory 22, an operation of the user interface 23, and the like. The processing circuitry 25 executes the process on the basis of programs (the operating system program, the driver programs, the application programs, and the like) stored in the memory 22. In addition, the processing circuitry 25 can execute a plurality of programs (application programs and the like) in parallel.

The processing circuitry 25 is configured to perform the functions of at least a terminal transmission/reception unit 251, a display processing unit 252, a game progressing unit 253, an input processing unit 254, and a mapping unit 255. Such units are functional modules realized by a program executed by a processor included in the processing circuitry 25. Alternatively, such units may be mounted in the mobile terminal 2 as firmware.

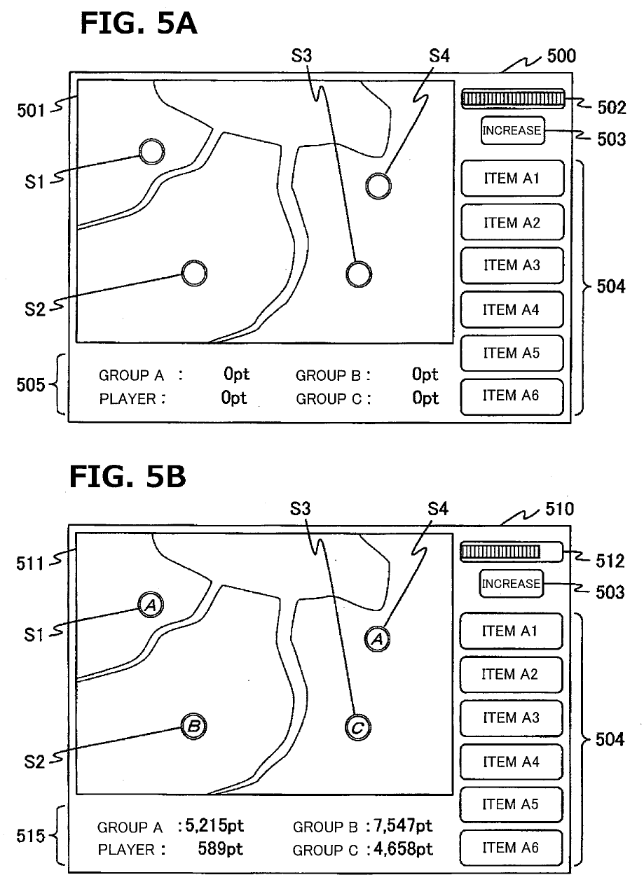

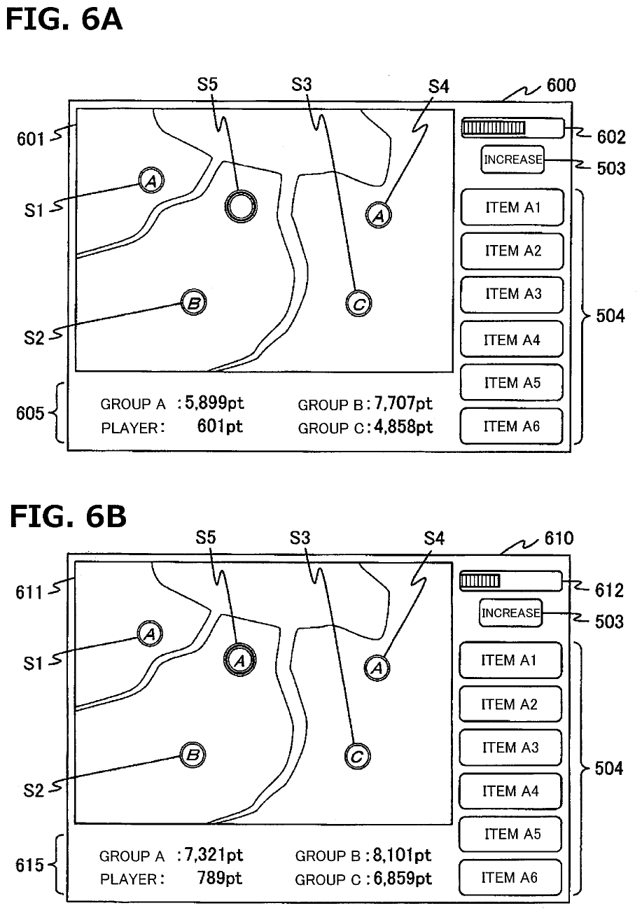

Hereinafter, an example of various views displayed on the display 24 of the mobile terminal 2 will be described with reference to FIGS. 5A to 6B.

FIG. 5A illustrates an example of a game view 500 displayed on the display 24 of the mobile terminal 2.

The game view 500 is displayed on the display 24 of the mobile terminal 2 owned by each belonging player of groups playing a battle game. In the game system 1, a plurality of groups are registered, and, when predetermined belonging players of one group among a plurality of groups invite participation to a battle game, and predetermined belonging players of another group apply for the participation invitation, the battle game is started. The battle game, for example, is executed for a predetermined game execution period (for example, for 30 minutes from a predetermined game start time) by three groups. Here, the number of groups that can participate in a battle game is not limited to three, and, when at least two groups participate in the battle game, the battle game is executed. In other words, when at least one group applies for the participation invitation, the battle game is executed. In other words, the battle game may be executed by an arbitrary number of groups that is two or more.

When a battle game is started, different attributes are automatically associated with groups participating in the battle game. Then, the attribute that is automatically associated with each group is set as an attribute corresponding to owned items of predetermined belonging players of the group. Hereinafter, a belonging player owning the mobile terminal 2 displaying the game view 500 may be simply referred to as a player.

In the game view 500, a display area 501 for game field, a consumption point gauge 502, a consumption point increase button 503, an owned item selection button 504, a point display area 505, and the like are displayed. While the game view 500 is displayed by a native application installed in the mobile terminal 2, display of parts such as the display area 501 and the like may be displayed by a web application on the basis of display data generated by the server 3.

The display area 501 for game field is a display area for displaying a game field of a battle game, and, inside the game field, site marks representing a plurality of sites (a site S1 to a site S4) are arranged.

The consumption point gauge 502 is a gauge representing consumption points owned by a player. The consumption points are points associated with each player, and whenever the owned item is associated with a site by the player, the consumption points decrease by one point. In the example illustrated in FIG. 5A, it is illustrated that maximum consumption points (for example, 250 points) are associated with the player by the consumption point gauge 502.

The consumption point increase button 503 is an operation button for increasing the consumption points associated with the player. In a case where the consumption point increase button is selected in accordance with an operation of the user interface 23 performed by the player, for example, 25 points are added to the consumption points associated with the player. In this case, in the consumption point gauge 502, a gauge representing consumption points after addition is displayed. In addition, in a case where the consumption point increase button is selected by the player, specific game contents associated with the player may be consumed. The specific game contents, for example, are points, items, virtual currency, or the like acquired by a player when another game or an event, or the like progresses.

The owned item selection button 504 is a selection button for selecting an owned item associated with a site by the player. In the example illustrated in FIG. 5A, owned items A1 to a6 of the player are displayed. Here, the number of the owned items displayed in the game view 500 is not limited to six. In the game view 500, all the owned items of the player may be displayed, or only owned items that are selected by the player in advance or randomly determined may be displayed. In addition, on the owned item selection button 504, the number of owned items corresponding to the owned item selection button 504 that are currently owned by the player may be displayed.

Hereinafter, an operation method for associating an owned item with a site will be described. First, a player taps a display position of a site mark of one site among the site S1 to the site S4 arranged inside the game field displayed in the display area 501 on the display screen of the display 24, thereby selecting an arbitrary site. Next, the player taps one owned item selection button 504 among the owned item selection buttons 504, thereby selecting the owned item selection button 504. Then, an owned item corresponding to the owned item selection button 504 selected by the player is associated with the site selected by the player.

In addition, after the player selects a site, the player may select a plurality of owned item selection buttons 504 among the owned item selection buttons 504. For example, after the player selects the site S1, the player may select the owned item selection button 504 corresponding to an owned item A1 twice and select the owned item selection button 504 corresponding to an owned item A2 three times. In such a case, two owned items A1 of the player are associated with the site S1, and three owned items A2 of the player are associated with the site S1. In this way, in a case where a plurality of owned items are desired to be associated with a site in a short time, the player can perform consecutive operations for the owned item selection button 504. Accordingly, the game system 1 can provide a fun of an action game for the player and can improve the operability of the player through a simple user interface.

In the point display area 505, a sum of site points associated with all the sites S1 to S4 is displayed for each group participating in the battle game, and a sum of associated points associated with all the sites S1 to site S4 by the player is displayed. Hereinafter, a sum of site points associated with all the sites S1 to S4 by each group may be referred to as group points of the group, and a sum of associated points associated with all the sites S1 to S4 by the player may be referred to as player points. In the example illustrated in FIG. 2A, the group points of the group A are 931,810 points (114,521+321,654+85,621+410,014).

FIG. 5B illustrates an example of the game view 510 displayed on the display 24 of the mobile terminal 2. In FIG. 5B, the same reference numeral is assigned to the same configuration as that of the game view 500 illustrated in FIG. 5A, and the description thereof will not be presented.

In a game view 510, an image representing a battle game that is in the middle of progress and the like are displayed. In a display area 511 for game field, a game field of the battle game that is in the middle of progress is displayed. Site points for each group are associated with each of a site S1 to a site S4 arranged inside the game field, and the site occupying group of each of the site S1 to the site S4 is identified on the basis of the site points of each group. In the example illustrated in FIG. 5B, the site occupying group of the site S1 is a group A, the site occupying group of the site S2 is a group B, the site occupying group of the site S3 is a group C, and the site occupying group of the site S4 is the group A. In addition, in the site mark of each site, an image that can be used for identifying the site occupying group of each site is displayed.

In a consumption point gauge 512, a gauge representing current consumption points of the player is displayed. In addition, in a point display area 515, the current group points of each group participating in a battle game and current player points of the player are displayed.

In addition, near the site mark representing each of the site S1 to the site S4 arranged inside the game field, acquired points of each site or the site points of each group for each site may be presented. Here, while the acquired points or the site points displayed near each site are displayed using numerical values, the points may be displayed using a symbol, an image diagram, or the like. For example, in a case where the quantity of the acquired points or the site points is represented as the number of “+” patterns, the points are displayed in a display form such as “A+++” for the group A, “B++” for the group B, “C+” for the group C, and the like.

FIG. 6A illustrates an example of the game view 600 displayed on the display 24 of the mobile terminal 2. In FIG. 6A, the same reference numeral is assigned to the same configuration as that of the game view 500 illustrated in FIG. 5A, and the description thereof will not be presented.

In a game view 600, an image and the like representing a battle game that is further progressed from the game view 510 are displayed. In a display area 601 for game field, a game field of the battle game that is in the middle of progress is displayed. Inside the game field, in addition to a site S1 to a site S4, a special site S5 is displayed. The special site S5 is a site that is displayed in a valid period for special site that is the same as the game execution period of the battle game that is in the middle of progress or a valid period for special site (for example, for two minutes) that is shorter than the game execution period. Similarly to the site S1 to the site S4, owned items and associated points corresponding to the owned items are associated with the special site S5 by a belonging player of each group. An attribute is not associated with the special site S5 and thus, even when a belonging player of a certain group associates an owned item with the special site S5, associated points that are 1.0 times the item points of the owned item are associated with the special site S5. In addition, an attribute associated with one of the site S1 to the site S4 may be associated with the special site S5.

In a consumption point gauge 602, a gauge representing the current consumption points of the player is displayed. In a point display area 605, the current group points of each group participating in the battle game and the current player points of the player are displayed.

FIG. 6B illustrates an example of a game view 610 displayed on the display 24 of the mobile terminal 2. In FIG. 6B, the same reference numeral is assigned to the same configuration as that of the game view 500 illustrated in FIG. 5A, and the description thereof will not be presented.

In a game view 610, an image representing a battle game that is further progressed from the game view 600 and the like are displayed. In a display area 611 for game field, a game field of the battle game that is in the middle of progress is displayed. Similarly to the site S1 to the site S4, site points for each group are associated with a special site S5 in correspondence with associated points associated by a belonging player, and the site occupying group of the special site S5 is identified on the basis of the site points of each group. In the example illustrated in FIG. 6B, the site occupying group of the special site S5 is the group A.

In a consumption point gauge 612, a gauge representing the current consumption points of the player is displayed. In a point display area 615, the current group points of each group participating in the battle game and the current player points of the player are displayed.

When a valid period for special site passes after the special site S5 is displayed, a belonging player of each group cannot designate the special site S5. In such a case, the attribute of the site occupying group of the special site S5 at a time point after the valid period is set in a predetermined area of the game field in a period for setting attribute (for example, for three minutes) shorter than the game execution period of the battle game that is in the middle of progress. Here, the predetermined area is the whole area of the game field or a partial area inside the game field. Hereinafter, an attribute set to a certain area may be referred to as an area attribute of the area.

In the period for setting attribute, in a case where an owned item is associated with one of sites arranged inside the predetermined area by a belonging player (in other words, a belonging player owing an owned item having the same attribute as the area attribute of the predetermined area) of a group having the same attribute as the area attribute of the predetermined area of the game field, points of predetermined times (for example, twice) of the associated points corresponding to the owned item may be set as new associated points of the site associated with the owned item.

In the period for setting attribute, in a case where an owned item is associated with one of the sites arranged inside the predetermined area by a belonging player of a group having an attribute inferior to the area attribute of the predetermined area of the game field, points of predetermined times (for example, 1.2 times) of the associated points corresponding to the owned item may be set as new associated points of the site associated with the owned item. In addition, as a predetermined multiplying factor for points for a belonging player of a group having an attribute inferior to the area attribute of the predetermined area of the game field, a value other than a predetermined multiplying factor of points for a belonging player of a group having the same attribute as the area attribute of the predetermined area of the game field is set.

In addition, in a case where an owned item is associated with a site, associated points may be set on the basis of a relation between the area attribute of the predetermined area of the game field and the attribute of the owned item together with a relation between the attribute of the owned item (the group of a belonging player associating the owned item) and the attribute of the site. For example, in a case where the site S1 associated with the attribute “Fire” is arranged in a predetermined area of the game field in which the area attribute “Water” is set, when a belonging player of a group having the attribute “Tree” associates an owned item (for example, item points are 1000 points) with the site S1, the attribute “Tree” of the group is inferior to the attribute “Fire” of the site S1, and thus, first, “800” points corresponding to 0.8 times the item points “1000” are calculated. Next, since the attribute “Tree” of the group is superior to the area attribute “Water” of the predetermined area of the game field, “960” points corresponding to 1.2 times the calculated “800” points are calculated as associated points. In this way, not only the attribute of the site but also the area attribute of the predetermined area of the field has an influence on the setting of the associated points, and accordingly, a game requiring a strategy in the operation of associating the owned item can be provided for a player.

In this way, by setting the special site S5 as the occupying site of a predetermined group, the possibility of the other sites S1 to S4 being an occupying site of a predetermined group increases, and accordingly, during the valid period for special site in which the special site S5 is displayed, the participation rate of a belonging player for the battle game can be increased. In addition, within the game execution period of the battle game, a plurality of kinds of special sites may be displayed. In such a case, every time the valid period of each of the plurality of kinds of special sites passes, each period for setting attribute is set.

In addition, the group point of each group displayed in the point display areas 505, 515, 605, and 615 may be a sum of the site points of the group associated with a part of the site S1 to the site S4. Furthermore, the player points of the player displayed in the point display areas 505, 515, 605, and 615 may be a sum of site points of the player associated with a part of the site S1 to the site S4.

(Configuration of Server 3)

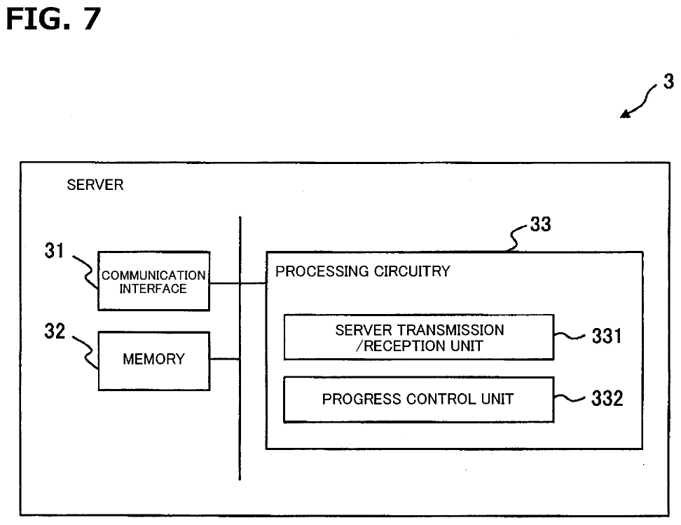

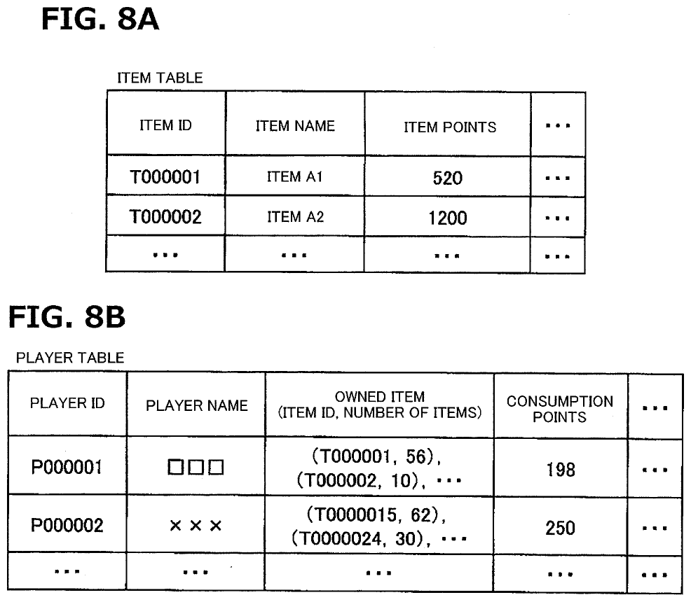

FIG. 7 illustrates an example of the schematic configuration of the server 3. In addition, FIGS. 8A to 11B illustrate an example of the data structures of various tables stored by a memory 32.

The server 3 includes a communication interface 31, a memory 32, and a processing circuitry 33. The server 3 progresses a battle game in response to a request from the mobile terminal 2. In addition, the server 3 generates display data relating to the progress of the battle game and the like and transmits the generated data to the mobile terminal 2.

The communication interface 31 include a communication interface circuit (not illustrated in the drawing) used for connecting the server 3 to the Internet 7 and communicates with the Internet 7. Then, the communication interface 31 supplies data received from the mobile terminal 2 and the like to the processing circuitry 33. In addition, the communication interface 31 transmits data supplied from the processing circuitry 33 to the mobile terminal 2 and the like.

The memory 32, for example, includes at least one of a magnetic tape device, a magnetic disk device, and an optical disc device. The memory 32 stores an operating system program, driver programs, application programs, data, and the like used for the process performed by the processing circuitry 33. For example, the memory 32, as the application programs, stores a game program which progresses a battle game and generates display data relating to a result thereof and the like. The computer program, for example, may be installed in the memory 22 from a computer-readable portable recording medium such as a CD-ROM or a DVD-ROM by using a known setup program or the like.

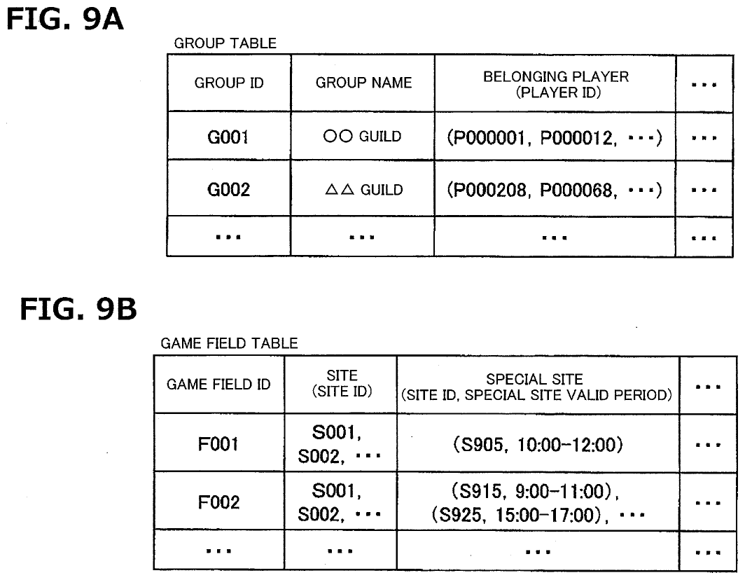

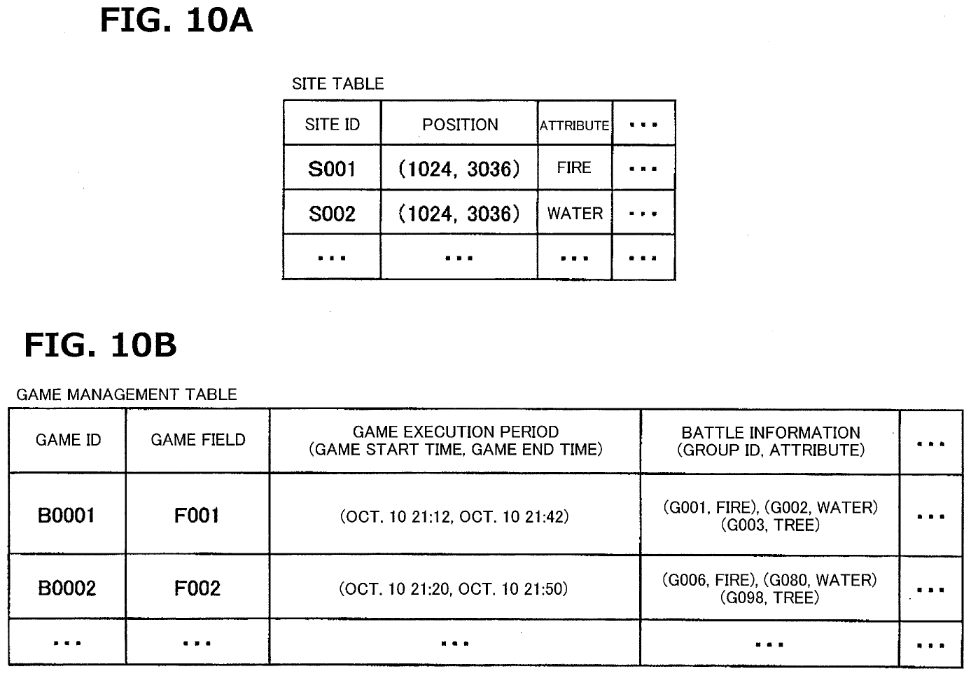

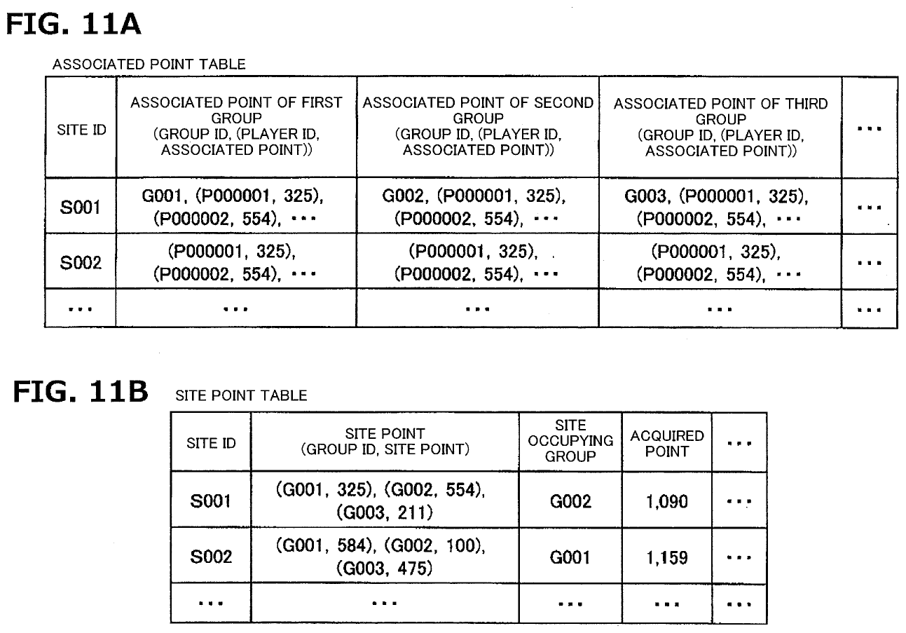

The memory 32, as data, stores an item table illustrated in FIG. 8A, a player table illustrated in FIG. 8B, a group table illustrated in FIG. 9A, a game field table illustrated in FIG. 9B, a site table illustrated in FIG. 10A, a game management table illustrated in FIG. 10B, an associated point table illustrated in FIG. 11A, a site point table illustrated in FIG. 11B, and the like. In addition, the memory 32 stores various kinds of image data and the like relating to the progress of a battle game. Furthermore, the memory 32 may temporarily store temporary data relating to a predetermined process. In other words, the memory 32 may include a volatile memory, for example, a random access memory (RAM) and store dynamic data changing in accordance with the progress of a battle game.

FIG. 8A illustrates an item table that manages items. In the item table, for each item, an item identification (ID), an item name, item points, and the like of the item are stored in association with each other. The item ID is an example of identification information used for uniquely identifying each item.

FIG. 8B illustrates a player table that manages players. In the player table, for each player, a player ID, a player name, owned items, consumption points, and the like of the player are stored in association with each other. The player ID is an example of identification information that is used for uniquely identifying each player. As the owned items, an item ID, the owned number, and the like of each owned item that is currently owned by each player are stored in association with each other. The consumption points are consumption points that are currently owned by each player.

FIG. 9A illustrates a group table that manages groups. In the group table, for each group, a group ID, a group name, belonging players, and the like of the group are stored in association with each other. The group ID is an example of identification information that is used for uniquely identifying each group. In addition, as belonging players, player IDs of the belonging players of each group are stored.

FIG. 9B illustrates a game field table that manages game fields. In the game field table, for each game field, a game field ID, sites, special sites and the like of the game field are stored in association with each other. The game field ID is an example of identification information that is used for uniquely identifying each game field. In addition, as sites, site IDs of the sites arranged inside each game field are stored. Furthermore, as special sites, a site ID of each special site arranged inside each game field and the valid period for special site are stored in association with each other. In addition, as the valid period for special site, for example, a start time and an end time of the valid period for special site are defined using elapsed times after a game start time. In the example illustrated in FIG. 9B, in a special site (site ID: “S905”) associated with a game field ID F001, it is represented that after 10 minutes 0 seconds from the game start time is the start time of the valid period, and after 12 minutes and 0 seconds from the game start time is the end time of the valid period.

FIG. 10A illustrates a site table that manages sites arranged inside a game field. The site table is managed for each game field, and, in the site table, for each site, a site ID, a position, an attribute, and the like of the site are stored in association with each other. The site ID is an example of identification information that is used for uniquely identifying each site. The position is arrangement position information of each site inside a game field. In a case where the game field is a two-dimensional virtual game space, the arrangement position information is position information representing two-dimensional coordinates. On the other hand, in a case where the game field is a three-dimensional virtual game space, the arrangement position information is position information representing three-dimensional coordinates.

FIG. 10B illustrates a game management table that is used for managing a battle game. In the game management table, for each battle game executed by the game system 1, a game ID, a game field, a game execution period, battle information, and the like of the battle game are stored in association with each other. The game ID is an example of identification information that is used for uniquely identifying each battle game. In addition, as a game field, a game field ID of a game field used in each battle game is stored.

In addition, as the game execution period, a game start time and a game end time of each battle game are stored. In the example illustrated in FIG. 10B, a time from the game start time to the game end time is 30 minutes. In addition, as the battle information, a group ID and an attribute of a group participating in each battle game are stored.

Each record stored in the game management table is generated, for example, in a case where predetermined belonging players of one group among a plurality of groups stored in the group table by the server 3 invite participation to a battle game, and, for the participation invitation, predetermined belonging players of other groups apply for the participation invitation. For example, when a predetermined number (for example, three) groups participating the battle game are determined, the server 3 stores a new game ID in the game management table. Next, the server 3 stores the game field ID of a game field that is automatically selected by the server 3 or selected by a predetermined player of a group participating in the battle game in the game management table in association with the stored new game ID. Next, the server 3 stores a game start time that is automatically determined by the server 3 or is directed by a predetermined player of a group participating in the battle game and a game end time that is after 30 minutes from the game start time in the game management table in association with the new game ID as a game execution period. The time until the game end time from the game start time is not limited to 30 minutes and, for example, may be one hour. Then, the server 3 stores the group ID of each group participating in the battle game in the game management table together with an attribute that is automatically selected in association with the new game ID as battle information.

FIG. 11A illustrates an associated point table that manages associated points in the battle game that is in the middle of progress. The associated point table is generated by the server 3 for each battle game. In the associated point table, for each site arranged inside the game field used in the battle game, a site ID of the site, associated points of a first group, associated points of a second group, associated points of a third group, and the like are stored in association with each other. As associated points of the first group, the group ID of one group among the groups participating in the battle game, a player ID of each belonging player of the group, and associate points of each belonging player are stored. The associated points of each belonging player are associated points of the belonging player for a site represented by the associated site ID. As associated points of the second group, the group ID of one group different from the first group among the groups participating in the battle game, a player ID of each belonging player of the group, and associate points of each belonging player are stored. As associated points of the third group, the group ID of one group different from the first group and the second group among the groups participating in the battle game, a player ID of each belonging player of the group, and associated points of each belonging player are stored.

FIG. 11B illustrates a site point table that manages site points in the battle game that is in the middle of progress. The site point table is generated by the server 3 for each battle game. In the site point table, for each site arranged in the game field used in the battle game, a site ID, site points, a site occupying group, acquired points, and the like of the site are stored in association with each other. In addition, as site points, the group ID of each group participating in the game and site points associated with each site by each group are stored. The site points are stored for each group every time the site points are added (updated). As the site occupying group, the group ID of the site occupying group of each site is stored by the server 3. In the site occupying group, every time site points are updated, the group ID of a group for the most points among site points of the groups is stored by the server 3. The acquired points are a sum of site points associated with each site by all the groups and are tabulated by the server 3 every time the site points are updated.

Referring back to FIG. 7, the processing circuitry 33 includes at least a server transmission/reception unit 331 and a progress control unit 332. Such units are functional modules realized by a program executed by a processor included in the processing circuitry 33. Alternatively, such units may be mounted in the server 3 as firmware.

Hereinafter, an example of the function of each of the terminal transmission/reception unit 251, the display processing unit 252, the game progressing unit 253, the input processing unit 254, and the mapping unit 255 included in the processing circuitry 25 of the mobile terminal 2 and the server transmission/reception unit 331 and the progress control unit 332 included in the processing circuitry 33 of the server 3 will be described.

(Function of Terminal Transmission/Reception Unit 251)

The terminal transmission/reception unit 251 receives game control data transmitted from the server 3 at the time of participating in the game through the communication interface 21. The game control data transmitted to the mobile terminal 2 at the time of participating in the game, for example, includes: a record (a player ID, a player name, owned items, consumption points, and the like of a player) relating to a player owning the mobile terminal 2 of a transmission destination that is stored in the item table and the player table; a record (a game field ID, sites, and special sites, and the like) relating to a game field used in the battle game, in which the player participates, that is stored in the game field table; a record (a game ID, a game field ID, a game execution period, the battle information, and the like) relating to the battle game, in which the player participates, that is stored in the site table relating to the game field used by the game in which the player participates and the game management table; the site point table; and the like. In addition, in the game control data, the record (a group ID, a group name, and belonging players) relating to a group, to which the player belongs, that is stored in the group table may be included.

When the game control data transmitted from the server 3 in the middle of the progress of a game is received through the communication interface 21, the terminal transmission/reception unit 251 transmits the received game control data to the game progressing unit 253. In addition, the game control data transmitted in the middle of the progress of the game includes the site point table that is updated by the server in accordance with the progress of the game.

The terminal transmission/reception unit 251 receives an end direction transmitted from the server 3 through the communication interface 21.

(Function of Display Processing Unit 252)

The display processing unit 252 generates drawing data on the basis of the game control data received by the terminal transmission/reception unit 251 and displays a game view 500, 510, 600, or 610 corresponding to the progress of the game on the display 24.

(Function of Game Progressing Unit 253)

The game progressing unit 253 directs the display processing unit 252 to display the game view based on the game control data transmitted from the server 3 at the time of participating in the game. In addition, the game progressing unit 253 stores owned items and consumption points of the player included in the game control data in the memory 22.

The game progressing unit 253 transmits game progress data to the server 3 through the communication interface 21 at a predetermined timing. The game progress data is various kinds of data that changes in accordance with a player's operation and, for example, includes the number of owned items of the player, the consumption points that are currently owned by the player, the associated points of the player of each site, and the like. In addition, in the game progress data, a player ID of the player is included in association with such various kinds of data. Furthermore, the predetermined timing, for example, is whenever a fixed period (one second or the like) elapses, when an owned item is selected or associated points are associated by the player, when the progress of the game ends, or the like.

In accordance with an end direction transmitted from the server 3, the game progressing unit 253 performs control such that a progressing process to be described later is not executed, and transmits the game progress data to the server 3 through the communication interface 21.

In a case where the owned item button is determined to have been selected in accordance with an input position detected by the input processing unit 254, the game progressing unit 253 determines whether or not the consumption points of the player stored in the memory 22 are larger than predetermined points (for example, zero point). Then, in a case where the consumption points of the player are determined to be the predetermined points or less by the game progressing unit 253, the game progressing unit 253 does not perform the process of associating the associated points with the site. Here, the predetermined points may be a point value of one or more.

In addition, in a case where the consumption point increase button is determined to have been selected in accordance with an input position detected by the input processing unit 254, the game progressing unit 253 determines whether or not the consumption points of the player stored in the memory 22 are an increase permission point or less. Here, the increase permission point may have any value equal to or smaller than a value calculated by subtracting the amount of increase in the consumption points according to one operation of the consumption point increase button from maximum consumption points, which can be owned by a player. For example, in a case where the maximum consumption point has a value of 250 points, and the amount of increase in consumption points according to one operation of the consumption point increase button is 25 points, the increase permission point may have a value of 225 points or less. Then, in a case where the consumption points of the player stored in the memory 22 are determined to be the increase permission point or less, the game progressing unit 253 adds 25 points to the consumption points associated with the player ID and stores consumption points after the addition in the memory 22 in association with the player ID. On the other hand, in a case where the consumption points of the player stored in the memory 22 are larger than the increase permission point, the addition of the consumption points is not performed. In this way, it can be prevented that an increase in the consumption points is less than a defined increased amount when the consumption point increase button 503 is operated once.

(Function of Input Processing Unit 254)

The input processing unit 254 detects an input position that is input in accordance with a player's operation of the user interface 23. In a case where the user interface 23 is a pointing device such as a touch panel, the input position, for example, is a position on the display screen which is input by a direction of the player.

In addition, the input processing unit 254 determines whether or not a site arranged inside the game field displayed on the display 24 has been selected in accordance with the detected input position. For example, the input processing unit 254 extracts the position of each site arranged inside the game field from the site table and determines whether or not the detected input position is included inside a predetermined area having the position of each site arranged inside the game field as its center.

In a case where a site is determined to have been selected in accordance with the detected input position, the input processing unit 254 detects an input position at which the next input is made in accordance with the operation of the user interface 23 that is performed by the player.

In addition, the input processing unit 254 determines whether or not the owned item button displayed on the display 24 has been selected in accordance with the detected input position. For example, the input processing unit 254 determines whether or not the detected input position is included inside the display area of the owned item button.

Furthermore, the input processing unit 254 determines whether or not the consumption point increase button displayed on the display 24 has been selected in accordance with a detected input position. For example, the input processing unit 254 determines whether or not the detected input position is included inside the display area of the consumption point increase button.

(Function of Mapping Unit 255)

In a case where the owned item button is determined to have been selected in accordance with the input position detected by the input processing unit 254, when the consumption points of the player is determined to be more than predetermined points (for example, zero points) by the game progressing unit 253, the mapping unit 255 performs a mapping process.

Hereinafter, the mapping process will be described. First, the mapping unit 255 identifies the site ID of a site determined to have been selected by the input processing unit 254 by referring to the site table and identifies the item ID of the owned item of the player that corresponds to the owned item button determined to have been selected by the input processing unit 254 by referring to the item table. Next, the mapping unit 255 subtracts one point from the consumption points of the player stored in the memory 22. Next, the mapping unit 255 decreases one from the number of owned items corresponding to the identified item ID that is stored in the memory 22.

Next, the mapping unit 255 extracts item points corresponding to the identified item ID by referring to the item table stored in the memory 22. Next, the mapping unit 255 extracts the attribute of the group to which the player belongs from the battle information stored in the memory 22 and sets the extracted attribute as the attribute of the owned item determined to have been selected. Next, the mapping unit 255 extracts an attribute corresponding to the identified site ID by referring to the site table.

Next, the mapping unit 255 changes the extracted item points on the basis of the superiority/inferiority relation between the attribute of the owned item and the attribute of each site, the set attribute of the owned item and the attribute corresponding to the identified site ID, which are stored in the memory 22, and stores the item points after the change in the memory 22 in association with the identified site ID as associated points. In addition, for each site ID, the mapping unit 255 stores a sum of associated points associated with the site ID for each group. In the way described above, the mapping process ends.

(Function of Server Transmission/Reception Unit 331)

The server transmission/reception unit 331 receives the game progress data transmitted from the mobile terminal 2 owned by the player through the communication interface 31 and transmits the game control data to the mobile terminal 2 owned by the player through the communication interface 31.

In addition, in a case where the current time is the game end time of the game execution period stored in the game management table, the server transmission/reception unit 331 transmits an end direction to the mobile terminal 2 owned by the player through the communication interface 31.

(Function of Progress Control Unit 332)

The progress control unit 332 directs the server transmission/reception unit 331 to transmit the game control data in response to a game participation request from a player. The game participation request from the player is transmitted from the mobile terminal 2 owned by a player in a case where the player participates in a game at a start time of the battle game or within the game execution period of the battle game.

In addition, the progress control unit 332 executes a progress control process on the basis of the game progress data received from the server transmission/reception unit 331. In the progress control process, first, the progress control unit 332 updates the player table stored in the memory 32 on the basis of the player ID of the player included in the game progress data, the number of owned items of the player, and the consumption points that are currently owned by the player. In other words, in the player table, as the number of the owned items and the consumption points of the player associated with the player ID, the number of owned items and the consumption points of the player included in the game progress data are stored. Next, the progress control unit 332 updates the associated point table on the basis of the associated points of the player of each site included in the game progress data. In other words, in the associated point table, as associated points of each site associated with the player ID, associated points of a player of each site included in the game progress data is stored. Then, the progress control unit 332 updates the site point table on the basis of the updated associated point table. In other words, every time the associated point table is updated, the progress control unit 332 calculates a sum of associated points of belonging players of each group for each site as a site point of each group for each site and stores the group ID of each group and the calculated site points for each site in the site point table in association with each other. In addition, every time the site points are stored, the progress control unit 332 stores the group ID of a group having the most points among the site points of the groups in the site point table for each site as a site occupying group. In addition, the progress control unit 332 stores a sum of site points associated with all the groups for each site in the site point table as acquired points. In this way described above, the progress control process performed by the progress control unit 332 ends. Here, the progress control unit 332 is an example of the point setting unit.

Furthermore, the progress control unit 332 transmits the game control data including the site point table updated by the progress control process to the mobile terminal 2 through the communication interface 31.

In addition, the progress control unit 332 executes a tabulation process on the basis of the game progress data transmitted from the mobile terminal 2 that has received the end direction. In the tabulation process, the player table, the associated point table, and the site point table are updated as in the progress control process. In addition, the progress control unit 332 may transmit the acquired points of each group to the mobile terminal 2 through the communication interface 31 as a result of the game. Here, the result of the game may be a rank of each group determined on the basis of the acquired points of each group.

(Operation Sequence of Game System 1)

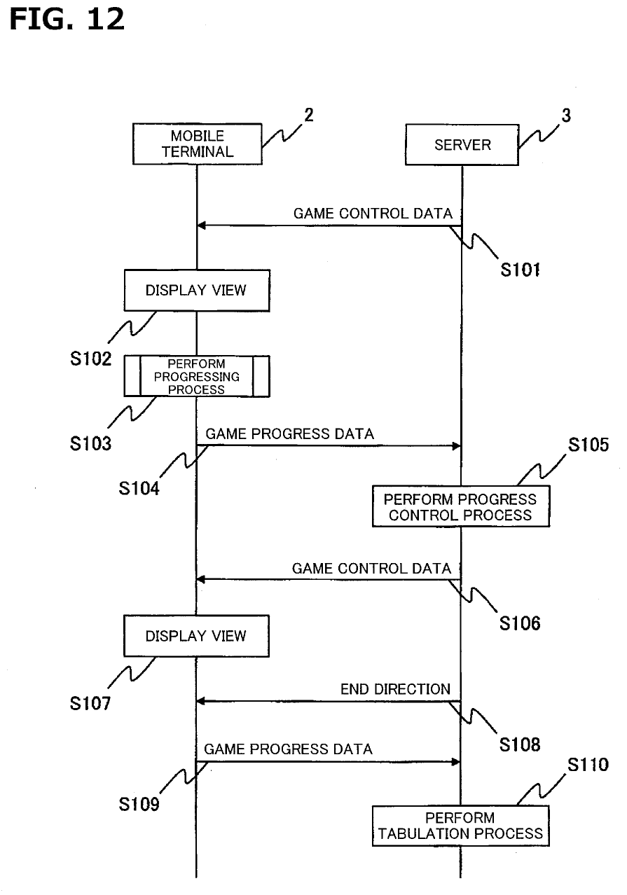

FIG. 12 illustrates one example of the operation sequence of the game system 1. This operation sequence is executed mainly by the processing circuitry 25 and the processing circuitry 33 in cooperating with the components of the mobile terminal 2 and the server 3 on the basis of programs stored in the memory 22 and the memory 32 in advance.

First, the progress control unit 332 of the server 3 directs the server transmission/reception unit 331 to transmit the game control data in response to a game participation request from a player. The server transmission/reception unit 331 transmits the game control data to the mobile terminal 2 owned by the player through the communication interface 31 in accordance with a direction from the progress control unit 332 (Step S101).

Next, when the game control data transmitted from the server 3 is received through the communication interface 21, the terminal transmission/reception unit 251 of the mobile terminal 2 transmits the received game control data to the game progressing unit 253. Next, the game progressing unit 253 transmits the game control data received from the terminal transmission/reception unit 251 to the display processing unit 252 and directs the display processing unit 252 to display a game view. Next, the display processing unit 252 generates drawing data on the basis of the received game control data and displays the game view 500, 510, 600, or 610 corresponding to the progress of a game on the display 24 (Step S102).

Next, the game progressing unit 253, the input processing unit 254, and the mapping unit 255 of the mobile terminal 2 executes a progressing process in accordance with an operation of the user interface 23 that is performed by the player (Step S103). Details of the progressing process will be described later.

Next, the game progressing unit 253 transmits game progress data to the server 3 through the communication interface 21 at a predetermined timing (Step S104).

Next, when the game progress data transmitted from the mobile terminal 2 is received through the communication interface 31, the server transmission/reception unit 331 of the server 3 transmits the received game progress data to the progress control unit 332. The progress control unit 332 executes a progress control process on the basis of the received game progress data (Step S105).

Next, the progress control unit 332 transmits game control data including the site point table updated by the progress control process to the mobile terminal 2 through the communication interface 31 (Step S106).

Next, when the game control data transmitted from the server 3 is received through the communication interface 21, the terminal transmission/reception unit 251 of the mobile terminal 2 transmits the received game control data to the game progressing unit 253. Next, the game progressing unit 253 transmits the game control data received from the terminal transmission/reception unit 251 to the display processing unit 252 and directs the display processing unit 252 to display a game view. Next, the display processing unit 252 generates drawing data on the basis of the received game control data and displays a game view 510, 600, or 610 corresponding to the progress of the game on the display 24 (Step S107).

In addition, Steps S104 to S107 described above may be performed a plurality of times at predetermined timings (for example, for every fixed period (one second or the like)). In addition, in Step S106, in a case where the current time is the start time of the valid period of a special site in the game field table, the server transmission/reception unit 331 of the server 3 may include as direction for display of the special site in the game control data. Instead of this, in a case where the current time is the start time of the valid period of a special site based on the special site included in the game control data retrieved in Step S101, the display processing unit 252 of the processing circuitry 25 may display the special site on the display 24.

In addition, in Step S106, in a case where the current time is the end time of the valid period of the special site included in the game field table, the server transmission/reception unit 331 of the server 3 may include a display end direction of the special site in the game control data. Instead of this, in a case where the current time is the end time of the valid period of the special site on the basis of the special site included in the game control data retrieved in Step S101, the display processing unit 252 of the processing circuitry 25 may end the display of the special site.

Next, in a case where the current time is the game end time of the game execution period included in the game management table, the server transmission/reception unit 331 of the server 3 transmits an end direction to the mobile terminal 2 owned by the player through the communication interface 31 (Step S108).

Next, when the end direction transmitted from the server 3 is received through the communication interface 21, the terminal transmission/reception unit 251 of the mobile terminal 2 transmits the received end direction to the game progressing unit 253. Next, when the end direction is received from the terminal transmission/reception unit 251, the game progressing unit 253 performs control such that the progressing process of Step S103 is not executed and transmits game progress data to the server 3 through the communication interface 21 (Step S109).

Then, when the game progress data transmitted from the mobile terminal 2 is received through the communication interface 31, the server transmission/reception unit 331 of the server 3 transmits the received game progress data to the progress control unit 332. The progress control unit 332 executes a tabulation process on the basis of the received game progress data (Step S110).

(Progressing Process)

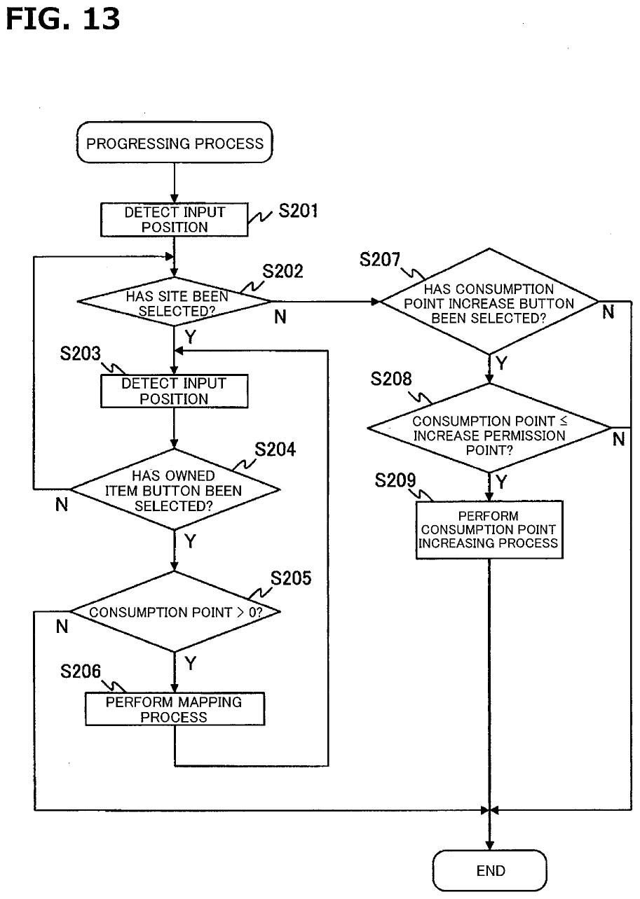

FIG. 13 illustrates one example of the operation flow of the progressing process using the game progressing unit 253, the input processing unit 254, and the mapping unit 255 of the mobile terminal 2. The progressing process illustrated in FIG. 13 is executed in Step S103 illustrated in FIG. 12.

First, the input processing unit 254 detects an input position at which input is made in accordance with a player's operation of the user interface 23 (Step S201).

Next, the input processing unit 254 determines whether or not a site arranged inside the game field displayed on the display 24 has been selected in accordance with the detected input position (Step S202).

In a case where it is determined that the site has been selected in accordance with the detected input position (Step S202: Yes), the input processing unit 254 detects an input position at which the next input is made in accordance with a player's operation of the user interface 23 (Step S203).

Next, the input processing unit 254 determines whether or not the owned item button displayed on the display 24 has been selected in accordance with the detected input position (Step S204).

In a case where the input processing unit 254 determines that the owned item button has not been selected in accordance with the input position detected by the input processing unit 254 (Step S204: No), the process of Step S202 is executed.

On the other hand, in a case where the input processing unit 254 determines that the owned item button has been selected in accordance with the detected input position (Step S204: Yes), the game progressing unit 253 determines whether or not the consumption points of the player stored in the memory 22 are more than zero point (Step S205).

In a case where the game progressing unit 253 determines that the consumption points of the player are more than zero point (Step S205: Yes), the mapping unit 255 performs a mapping process (Step S206). After the mapping process is executed, the process of Step S203 is executed.

In a case where the game progressing unit 253 determines that the consumption points of the player are not more than zero (Step S205: No), a series of steps is ended.

In a case where it is determined that a site has not been selected in accordance with the detected input position (Step S202: No), the input processing unit 254 determines whether or not the consumption point increase button displayed on the display 24 has been selected in accordance with the detected input position (Step S207).

In a case where it is determined that the consumption point increase button has not been selected in accordance with the detected input position (Step S207: No), a series of steps is ended.

On the other hand, in a case where it is determined that the consumption point increase button has been selected in accordance with the detected input position (Step S207: Yes), the game progressing unit 253 determines whether or not the consumption points of the player stored in the memory 22 are the increase permission point or less.

In a case where the consumption points of the player stored in the memory 22 are determined to be more than the increase permission point (Step S208: No), a series of steps is ended.

On the other hand, in a case where the consumption points of the player stored in the memory 22 are determined to be the increase permission point or less (Step S208: Yes), the game progressing unit 253, for example, adds 25 points to the consumption points associated with the player ID and stores the consumption points after the addition in the memory 22 in association with the player ID (Step S209), and a series of steps is ended.

As described above in detail, for each of a plurality of sites, a sum of associated points corresponding to the owned items associated with belonging players of each group is calculated and is stored as site points of each group for each of a plurality of sites.

A game progresses on the basis of site points of each group for each of the plurality of sites. Accordingly, in a game realized by this game device, for example, a player is requested to have strategy planning such as not associating his owned items with a site that is not to be an occupied site of the group. In this way, the game device can improve the amusement of the game.

### Modified Example 1

The present disclosure is not limited to this embodiment. For example, the progress control unit 332 may calculate a game result by adding group points to acquired points for each group and transmit the game result of each group to the mobile terminal 2 through the communication interface 31. In addition, the game result may be a rank of each group determined on the basis of a sum of the acquired points and the group points of each group. In the example illustrated in FIGS. 2A and 2B, a sum of site points of the group A for all the sites is 931,810 points, and the acquired points of the group A are 1,251,159 points. Accordingly, the game result of the group A is 2,182,969 points. Accordingly, in the game system 1, the game result is changed in accordance with a result (group points) of the participation of the player in the game and a result (acquired points) of an encampment battle game requiring a strategy. In this way, according to the game system 1, a game requesting a player to have strategy planning is realized, and the amusement of the game can be markedly improved.

### Modified Example 2

In addition, in a case where an attribute is associated with a special site, a privilege may be given to the site occupying group of the special site in accordance with the attribute of the special site and the attribute of the site occupying group.

For example, in a case where a group having the same attribute as the attribute of the special site is the site occupying group of the special site, predetermined points may be added to acquired points of the site occupying group for a site occupied by the site occupying group other than the special site. For example, as the acquired points of the site occupying group for the site, points that are a predetermined number of times (for example, twice) the sum of site points associated with the site by all the groups may be set with respect to the site. In this way, in a normal case, while a sum of site points associated with each site by all the groups is set as the acquired points of the site occupying group, a bonus can be given to the acquired points for a group having a special site having the same attribute as the attribute of the group as an occupied site.

In addition, for example, in a case where a group having an attribute different from the attribute of the special site becomes a site occupying group of the special site, the attribute of one of sites having the same attribute as the attribute of the special site among sites other than the special site may be changed to the attribute of the site occupying group.

In addition, in the process of giving a privilege to a site occupying group, a combination of a condition of the attribute relation between a special site and the site occupying group and a privilege given is not limited to the example described above. For example, in a case where a group having the same attribute as the attribute of a special site becomes a site occupying group of the special site, the attribute of one of sites having the same attribute as the attribute of the special site among sites other than the special site may be changed to the attribute of the site occupying group. In addition, in a case where a group having an attribute different from the attribute of a special site becomes a site occupying group of the special site, predetermined points may be added to acquired points of the site occupying group for a site occupied by the site occupying group other than the special site.

In this way, since a change in the attribute or acquired points of a site occurs in accordance with a relation between the attribute of the special site and the attribute of each group, the player needs to consider whether to occupy a site or not by further pondering the strategy, and a game having a high degree of amusement can be provided.

### Modified Example 3

In addition, in a period for setting attribute, the game progressing unit 253, for at least a part of the area of the game field, may set the attribute of the site occupying group of a special site relating to the period. In such a case, in a case where a belonging player of a group having the same attribute as an attribute set in a part of the game field associates an owned item with a site included in the area in which the attribute is set, associated points corresponding to the owned item associated with the site may be increased or decreased. For example, points of a predetermined number of times (for example, twice) the associated points corresponding to an owned item may be associated, as new associated points, with a site with which the owned item is associated.

### Modified Example 4

In addition, the game progressing unit 253, at a game start time or a predetermined timing during a game execution period, may set an area attribute to each of a plurality of areas included in the game field. In such a case, in a case where a belonging player of a group having the same attribute as the area attribute of each area associates an owned item with a site included in each area, associated points corresponding to the owned item may be increased or decreased. For example, points of a predetermined number of times (for example, twice) the associated points corresponding to an owned item may be associated, as new associated points, with a site with which the owned item is associated.

### Modified Example 5

In addition, in a case where a special site associated with an area included in a game field is set, when a predetermined condition is satisfied, the game progressing unit 253 may change the area attribute of at least one area among a plurality of areas and change the attribute of a site included in the area of which the area attribute has been changed. For example, the predetermined condition is that the attribute of a special site associated with an area is changed to the attribute of a site occupying group of the special site. In such a case, the area attribute of the area associated with the special site may be changed to the attribute of the site occupying group of the special site.

In addition, the game progressing unit 253, during the period for setting attribute or after the period for setting attribute, may change the area attribute of an area corresponding to a special site to the attribute of the site occupying group of the special site. During the period for setting attribute, every time the site point is updated, the site occupying group of the special site may be changed each time. In such a case, the area attribute of each area is changed at each time in accordance with the progress of the game, and a game having a high degree of real time and a high degree of amusement for a player can be provided. For example, in a case where associated points associated, by a belonging player of a group having the same attribute as the area attribute set in the area, with a site included in an area in which an area attribute is set are increased or decreased, the area attribute of each area is changed each time as well in accordance with the progress of the game, and accordingly, a site for which the associated points are increased or decreased is changed each time. In this way, fun according to being incapable of predicting the quantity of associated points can be provided for a player, and a game having a high degree of real-time and requiring various strategies can be provided.

### Modified Example 6

In addition, in a case where an area attribute is set for each of a plurality of areas included in the game field, and a plurality of special sites having the same attribute as the area attribute of each area are set, the game progressing unit 253 may change the size of an area corresponding to a special site in accordance with the attribute of the site occupying group of the special site. For example, when the attribute of a special site is changed to the attribute of the site occupying group of the special site, the game progressing unit 253 may change the size of a predetermined area in accordance with the number of special sites having the same attribute as the area attribute of a predetermined area. In addition, for example, in a case where the attribute of each site is changed as each belonging player associates his owned item with each site, and the area attribute of the area is changed according to the change described above, the size of each area is changed each time as well in accordance with the progress of the game. In this way, the size of the area in which the area attribute is set is changed in accordance with the progress of the game, whereby fun of being incapable of predicting the quantity of associate points can be provided for the player.

### Modified Example 7

In addition, the game progressing unit 253 may identify areas having the same area attribute among a plurality of areas, calculate distance between the identified areas, and change the areas in accordance with the calculated distances. For example, a distance between the identified areas is a shortest distance between outer shape frames defining the shapes of the areas, a distance between farthest ends of the outer shape frames, a distance between centers of the areas, or the like. Then, in a case where at least two areas of which the calculated distance is a predetermined value or less are extracted, a composite area including the extracted areas may be determined. In addition, the composite area includes at least two areas of which the distance is the predetermined value or less and an area between the two areas, and the same area attribute as that of the at least two areas is set in the composite area. On the other hand, in a case where at least two areas of which the calculated distance is a predetermined value or less are not extracted, the process of generating a composite area described above is not executed, and the plurality of areas are set as different areas. In addition, the process of calculating at least two areas of which the distance between the identified areas is a predetermined value or less may be a process where a rectangular area which includes the identified two areas and which has a smallest area is identified, and two areas for which the area of the identified rectangular area is a predetermined value or less are calculated. Here, the two areas are examples of a first area and a second area.

### Modified Example 8

In addition, at least a part of various processes executed by the game progressing unit 253, the input processing unit 254, and the mapping unit 255 of the mobile terminal 2 described above may be configured to be executed also by the processing circuitry 33 of the server 3. Accordingly, the server 3 can receive game progress data including a result of a predetermined process of the mobile terminal 2, compare the result of the predetermined process included in the game progress data with a result of a corresponding process executed by the processing circuitry 33, and check the matching of the process executed by the mobile terminal 2.

### Modified Example 9

In addition, various processes executed by the game progressing unit 253, the input processing unit 254, and the mapping unit 255 of the mobile terminal 2 described above may be executed by the processing circuitry 33 of the server 3. In such a case, the server 3 does not need to transmit various tables to the mobile terminal 2 and transmits display data used for displaying various game views to the mobile terminal 2 for each process. In this case, for example, each game view is displayed by a web application in the mobile terminal 2 on the basis of the display data generated by the server 3.

### Modified Example 10

In addition, the game system 1 may have a configuration including only a plurality of mobile terminals 2 operated by a plurality of players. Each of the plurality of mobile terminals 2 executes radio communication with other mobile terminals 2 by using a predetermined communication system, and an ad hoc network is configured by a plurality of mobile terminals 2. In this case, a first mobile terminal 2 among the plurality of mobile terminals 2 functions as a host and executes each function of the server 3 described above. Among the plurality of mobile terminals 2, mobile terminals 2 other than the first mobile terminal 2 communicate with the first mobile terminal 2 executing each function of the server 3, whereby the game described above is executed. In addition, the first mobile terminal 2 functioning as a host executes both the function of the server 3 and the function of the mobile terminal 2. The predetermined communication system, for example, is a radio communication system of the IEEE802.11 standard or the like.

### Modified Example 11

In addition, as a battle game executed by the game system 1 according to this embodiment, although the GvG game has been described as an example, the game system 1 may execute a player versus player (PvP) game. In such a case, the game system 1 executes a process that is substantially the same as the process executed in a GvG game in a case where one player belongs to each group.

### Modified Example 12

In addition, before a battle game is started, the progress control unit 332 of the server 3 may automatically set mutually-different attributes to at least two owned items among owned items of players. In addition, in a case where an attribute associated with each item is stored in the item table in advance, the progress control unit 332 may set an attribute associated with an item corresponding to the owned item extracted from the item table as an attribute of the owned item of each player. Furthermore, by storing an item ID, the number of owned items, and an attribute in the player table as the owned item of each player, the attribute of the owned item of each player is set. In this case, the site points of each site are tabulated not for each group but for each attribute. Then, among site points of the site tabulated for each attribute, a group corresponding to the attribute of the most site points becomes the site occupying group of the site. Accordingly, in a case where a player of the first group desires that another group become a site occupying group of a specific site, the player can support the another group by associating an owned item corresponding to the attribute of the another group with the site. In this way, a game requiring various strategies can be realized without adding a new interface.

### Modified Example 13

In addition, before a battle game is started, to at least one player among players belonging to a group, the progress control unit 332 of the server 3 may automatically set an attribute different from the attribute of the group. In such a case, the progress control unit 332 sets an attribute that is set to each player as an attribute corresponding to an owned item of the player. In addition, by storing an attribute associated with each player in the player table, the attribute of each player is set. Furthermore, by storing an item ID, the number of owned items, and an attribute in the player table as the owned item of each player, the attribute of the owned item of each player is set. In this case, the site points of each site are tabulated not for each group but for each attribute. Then, among the site points of the site tabulated for each attribute, a group corresponding to an attribute of the most site points becomes the site occupying group of the site. Accordingly, in a case where the first group desires that another group become the site occupying group of a specific site, a player corresponding to the attribute of the another group among players belonging to the first group associates his owned item with the site, thereby supporting the another group. In this way, a game requiring various strategies can be realized without adding a new interface.

### Modified Example 14

In addition, a special site may be changed in accordance with the attribute of an area inside the game field. For example, in a case where the size of an area inside the game field is changed in accordance with the progress of a game, the display processing unit 252 may display a special site corresponding to the area attribute of the area in accordance with the size of the area. For example, as the area increases, the number of special sites corresponding to the area attribute of the area is set. Here, the special sites corresponding to the area attribute, for example, are a special site corresponding to the same attribute as the area attribute, a special site corresponding to an attribute (an attribute superior to the area attribute or the like) having a predetermined relation with the area attribute, and the like. In this way, player's eagerness for the participation in the game can be increased.

### Modified Example 15

In addition, in a case where a plurality of battle games progress in a same period, by allowing each player belonging to a group to participate in any one of the plurality of battle games, players belonging to the group may be allowed to participate in a plurality of battle games in a distributed manner. In such a case, the game field of each battle game may have an influence on a different game field.

For example, in a case where game fields are adjacently arranged inside a predetermined game space, an area corresponding to a predetermined area attribute of which the size is changed inside each game field may be enlarged inside another adjacent game field. In other words, a plurality of game fields progressed by different battle games function as a part of one game field relating to the setting of the area attribute.

In addition, for example, a predetermined position or area inside each game field may be associated with a predetermined position or area of another game field. In such a case, when the area attribute of a predetermined position or area inside each game field is changed, the area attribute of an associated position or area of another game field is also changed in a predetermined period. For example, a plurality of game fields may be configured to have a hierarchical relation overlapping in the height direction of a predetermined two-dimensional plane, and positions or areas overlapping each other between the game fields may be configured to be associated with each other.

In this way, a game field of each battle game is configured to have an influence on a game field of another battle game, and accordingly, by only adding a function for reading the status of other battle games, a game requiring a strategy according to the progress of the other battle games can be provided.

### Modified Example 16

In addition, in accordance with a sum of site points or acquired points of each group in the progress of a battle game, a special site having an attribute corresponding to the attribute of the group may be displayed. For example, the display processing unit 252 may identify a group having a largest sum of site points or the most acquired points and newly display a special site having the same attribute as the attribute of the identified group. In addition, for example, the display processing unit 252 may identify a group having a sum of site points or acquired points of the group that exceeds a predetermined site generation points and newly display a special site having the same attribute as that of the identified group. In this way, a game in which a group can progress the battle game advantageously in accordance with the degree of participation of a player can be provided.

It should be understood that, without departing from the spirit and the scope of the present disclosure, a person skilled in the art can perform various changes, substitutions, and modifications therein.

1-20. (canceled)

21. A non-transitory computer-readable recording storage medium containing a program, which when executed by processing circuitry, causes the processing circuitry to:
store, in a memory, control data including user data and site data regarding a plurality of sites displayed on a display screen of a touch panel user interface;
receive a first signal from the touch panel user interface indicative of a first user input to the display screen at a position corresponding to a first site of the plurality of sites;
receive, subsequent to receipt of the first signal, second signals from the touch panel user interface indicative of a plurality of second user inputs to the display screen at one or more positions corresponding to one or more user items held by a user;
in response to receiving the first and second signals, update game progress data stored in the memory;
at a first predetermined timing, transmit the updated game progress data to a server;
at a second predetermined timing, receive updated control data from the server including updated user data and updated site data; and
in response to receiving the updated control data, store the updated control data in the memory and cause the display screen of the touch panel user interface to reflect the updated user data and the updated site data.

22. The non-transitory computer-readable recording storage medium according to claim 21, wherein
in response to receiving the first and second signals, the game progress data stored in the memory is updated to associate the one or more user items with the first site.

23. The non-transitory computer-readable recording storage medium according to claim 21, wherein
the control data further includes virtual space data regarding a virtual space defined partly by the plurality of sites.

24. The non-transitory computer-readable recording storage medium according to claim 21, wherein
the game progress data includes the number of user items held by the user and points associated with the user.

25. The non-transitory computer-readable recording storage medium according to claim 21, wherein
the display screen is caused to reflect the updated user data and the updated site data by generating new drawing data of a virtual space defined partly by the plurality of sites.

26. The non-transitory computer-readable recording storage medium according to claim 21, wherein
the number of user items held by the user decreases in response to the second user inputs.

27. A method performed by processing circuitry, the method comprising:
storing, in a memory, control data including user data and site data regarding a plurality of sites displayed on a display screen of a touch panel user interface;
receiving a first signal from the touch panel user interface indicative of a first user input to the display screen at a position corresponding to a first site of the plurality of sites;
receiving, subsequent to receipt of the first signal, second signals from the touch panel user interface indicative of a plurality of second user inputs to the display screen at one or more positions corresponding to one or more user items held by a user;
in response to receiving the first and second signals, updating game progress data stored in the memory;
at a first predetermined timing, transmitting the updated game progress data to a server;
at a second predetermined timing, receiving updated control data from the server including updated user data and updated site data; and
in response to receiving the updated control data, storing the updated control data in the memory and causing the display screen of the touch panel user interface to reflect the updated user data and the updated site data.

28. The method according to claim 27, wherein
in response to receiving the first and second signals, the game progress data stored in the memory is updated to associate the one or more user items with the first site.

29. The method according to claim 27, wherein
the control data further includes virtual space data regarding a virtual space defined partly by the plurality of sites.

30. The method according to claim 27, wherein
the game progress data includes the number of user items held by the user and points associated with the user.

31. The method according to claim 27, wherein
the display screen is caused to reflect the updated user data and the updated site data by generating new drawing data of a virtual space defined partly by the plurality of sites.

32. The method according to claim 27, wherein
the number of user items held by the user decreases in response to the second user inputs.

33. An electronic device comprising:
processing circuitry configured to
store, in a memory, control data including user data and site data regarding a plurality of sites displayed on a display screen of a touch panel user interface;
receive a first signal from the touch panel user interface indicative of a first user input to the display screen at a position corresponding to a first site of the plurality of sites;
receive, subsequent to receipt of the first signal, second signals from the touch panel user interface indicative of a plurality of second user inputs to the display screen at one or more positions corresponding to one or more user items held by a user;
in response to receiving the first and second signals, update game progress data stored in the memory;
at a first predetermined timing, transmit the updated game progress data to a server;
at a second predetermined timing, receive updated control data from the server including updated user data and updated site data; and
in response to receiving the updated control data, store the updated control data in the memory and cause the display screen of the touch panel user interface to reflect the updated user data and the updated site data.

34. The electronic device according to claim 33, wherein
in response to receiving the first and second signals, the game progress data stored in the memory is updated to associate the one or more user items with the first site.

35. The electronic device according to claim 33, wherein
the control data further includes virtual space data regarding a virtual space defined partly by the plurality of sites.

36. The electronic device according to claim 33, wherein
the game progress data includes the number of user items held by the user and points associated with the user.

37. The electronic device according to claim 33, wherein
the display screen is caused to reflect the updated user data and the updated site data by generating new drawing data of a virtual space defined partly by the plurality of sites.

38. The electronic device according to claim 33, wherein
the number of user items held by the user decreases in response to the second user inputs.
